(19) United States
(12) Patent Application Publication
(10) Pub. No.: US 2020/0084670 A1
(43) Pub. Date: Mar. 12, 2020

(54) METHOD OF MANAGING RESOURCES OF A NETWORK

(71) Applicant: Waterford Institute of Technology, Waterford (IE)

(72) Inventors: Steven Davy, Waterford (IE); Alan Davy, Waterford (IE)

(21) Appl. No.: 16/469,905

(22) PCT Filed: Dec. 8, 2017
(86) PCT No.: PCT/EP2017/082089

§ 371 Date: Jun. 14, 2019

(30) Foreign Application Priority Data
Dec. 14, 2016 (GB) 1621297.9

(51) Int. Cl. H04W 28/20; H04W 8/22; H04W 8/18

(52) U.S. Cl. CPC H04W 28/20; H04W 84/12; H04W 8/18; H04W 8/22

(57) ABSTRACT

A method of managing resources of a network comprising a profile mapping step and an orchestration step. The profile mapping step comprises assigning a profile to an end user device, and the orchestration step comprising using the profile to apply rules to network elements to manage resources of the network available to the end user device.

The invention relates to a method of managing resources of a network and a resource management system.

In wireless communications networks, end user devices establish a wireless data connection to wireless access points distributed across a physical location. These access points may be distributed in such a way that many users can make a data connection and can be mobile throughout the physical location, maintaining the data connection during handover between access points.

Not all end users make use of the wireless network resources in the same way. Some may use minimal data bandwidth and have relatively little mobility, such as printers or temperature sensors, while others may require low latency data connections, and be more mobile, such as mobile phones.

Policy based network management systems use a firewall to determine a type of traffic being transmitted through a network. Such systems apply policies to the network so that all traffic of the same type is treated in the same way. Policy based network management systems provide no specific management for particular end user devices.

According to a first aspect of the invention, there is provided a method of managing resources of a network, the method comprising: a profile mapping step comprising assigning a profile to an end user device; and an orchestration step comprising using the profile to apply rules to network elements to manage resources of the network available to the end user device. This means that resources of the network can be better distributed between end user devices, helping the network to more precisely provide the resources required by the end user devices.

In one example, the method comprises a profile editing step, the profile editing step comprising performing an initial selection of the profile before the profile mapping step. This allows a profile to be selected for a device without requiring patterns of behaviour of the device to be observed. It is particularly useful when an end user device is first connected to the network.

In one example, the initial selection of the profile depends on at least one of a class of the end user device and an end user subscription class.

In one example, the method comprises a profile building step, the profile building step comprising learning from patterns of behaviour of the end user device to build the profile before the profile mapping step. This means that the profile and the resource management can be better tailored to the needs of the end user device.

In one example, the patterns of behaviour comprise a mobility speed of the end user device.

In one example, the patterns of behaviour comprise a traffic type of the end user device. This means that more appropriate resources (e.g. bandwidth or latency of connection) can be provided to the end user based on the traffic type of the end user device.

In one example, the patterns of behaviour comprise a mobility frequency of the end user device. This means that resources can be managed based on the mobility of the end user device. For example, for a more mobile end user device, the network may proactively hand over the end user device to another wireless access point, with a hand over taking place when signal strength falls to a higher threshold value (i.e. fast handover). A less mobile end user device may have a lower threshold for wireless access point hand over (i.e. slow handover).

In one example, the patterns of behaviour comprise an average data rate usage of the end user device.

In one example, the patterns of behaviour are collected from at least one of a firewall, a wireless LAN controller and a switch.

In one example, the method comprises a further profile building step, a further profile mapping step, and a further orchestration step.

In one example, the rules determine bandwidth available to the end user device.

According to a second aspect of the invention, there is provided a resource management system for a network, the resource management system comprising: a profile mapper adapted to assign a profile to an end user device; and an orchestration component adapted to use the profile to apply rules to network elements to manage resources of the network available to the end use device.

For a better understanding of the invention reference is made, by way of example only, to the accompanying figures, in which:

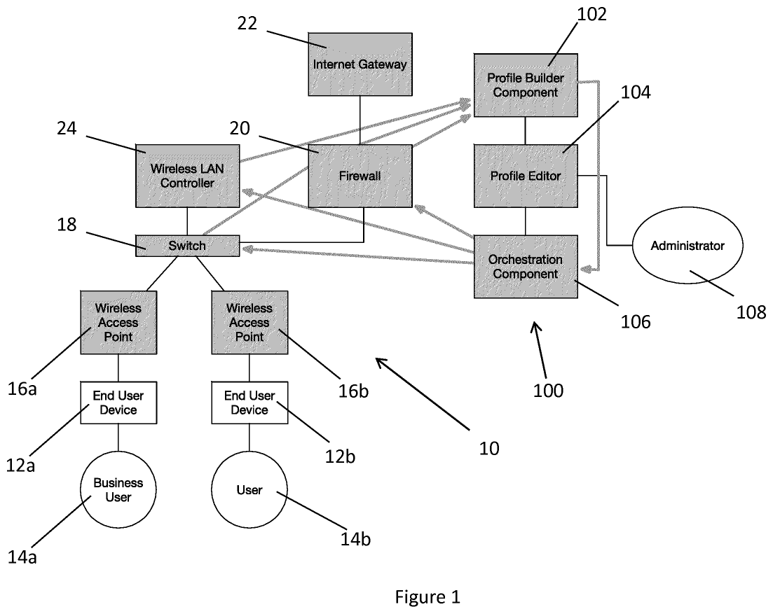

FIG. 1 is a schematic drawing of a network; and

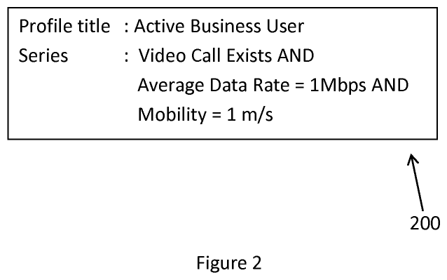

FIG. 2 is an illustration of a profile.

Referring to FIG. 1 there is shown a network 10. The network 10 comprises a first end user device 12a belonging to a business user 14a, and a second end user device 12b belong to a user 14b.

The first end user device 12a connects to a first wireless access point 16a. The second end user device 12b connects to a second wireless access point 16b.

The network 10 comprises network elements, including a switch 18, a firewall 20 and a Wireless LAN controller 24. The first and second wireless access points 16a 16b connect to the switch 18, which connects to the firewall 20, which connects to the internet gateway 22. The switch 18 is controlled by a wireless LAN controller 24.

The network 10 comprises a resource management system 100. The resource management system 100 comprises a profile mapper, the profile mapper comprising a profile builder component 102 and a profile editor 104. The resource management system 100 comprises an orchestration component 106 and an administrator 108.

In use, when an end user device 12a 12b is first connected to the network 10, an administrator 108 uses a profile editor 104 to perform an initial selection of a profile for each end user device 12a 12b. The administrator 108 initially selects the profile depending on the class of end user device 12a 12b and the subscription class of the end user 14a 14b.

The profile editor 104 communicates the profile to the profile builder component 102. The profile builder component 102 assigns the profile to the end user device 12a 12b, and communicates the profile to the orchestration component 106. The orchestration component 106 uses the profile to apply rules to the network elements to manage resources of the network available to the end user device 12a 12b. The rules chosen by the orchestration component 106 are appropriate for the profile which has been assigned to the end user device 12a 12b. The orchestration component 106 applies the rules to the switch 18, the firewall 20 and the wireless LAN controller 24, which manage the proportion of the resources given to the end user device 12a 12b by the network. The end user device 12a 12b is identified by the network elements using the end user device's 12a 12b MAC address.

The end user device communicates with the internet gateway 22 via the switch 18 and the firewall.

When the end user device 12a 12b connects to the network 10 and establishes a data connection, the profile builder component 102 begins to receive information on patterns of behaviour of the end user device 12a 12b from the switch 18, the firewall 20 and the wireless LAN controller 24. The patterns of behaviour comprise a mobility speed of the end user device 12a 12b (i.e. physical speed of the end user device 12a 12b). The patterns of behaviour comprise a mobility frequency (i.e. frequency of physical movement of the end user device 12a 12b). The patterns of behaviour comprise a traffic type of the end user device 12a 12b (i.e. whether the end user device is used for video calling). The patterns of behaviour comprise an average data rate usage of the end user device 12a 12b.

The profile builder component 102 learns from the patterns of behaviour of the end user device 12a 12b to build an updated profile for the end user device 12a 12b. The profile lists a series of end user device patterns of behaviour. Additionally, the profile depends on a class of the end user device 12a 12b (e.g. an Internet of Things device, or a mobile phone) and the subscription class of the end user 14a 14b (e.g. whether user pays for a premium subscription). An example profile is described below with respect to FIG. 2.

The profile builder component 102 assigns the updated profile to the end user device 12a 12b, and communicates the updated profile to the orchestration component 106. The profile building (by the profile builder component 102) occurs after the profile editing (by the profile editor 104). This means that the updated profile built by the profile builder component 102 supersedes the profile initially selected by the profile editor 104. As before, the orchestration component 106 uses the updated profile to apply rules to the network elements.

The process continues, with the profile builder component 102 continuing to receive information on patterns of behaviour of the end user device 12a 12b, and continuing to learn from the patterns of behaviour to update the profile for the end user device 12a 12b. The profile builder component 102 continues to communicate updated profiles to the orchestration component 106, ensuring that the rules applied to the network elements are up to date based on the current behaviour of the end user device 12a 12b. The frequency at which the profile is updated by the profile builder component 102 is defined on a per profile basis, and will be between once every few milliseconds and once every few hours. Typically, the profile is updated once every few seconds.

In an alternative example, the network does not include a profile editor, and each end user device 12a 12b simply remains in its default configuration until a profile has been built by the profile builder component 102.

In an alternative example, end user devices are authenticated when they connect to the network, and the network uses the authentication of the end user device to identify the device when collecting information on patterns of behaviour of the end user device and when applying rules to the end user device.

Referring to FIG. 2, there is shown a profile 200 which has been built for the first end user device 12a by the profile builder component 102. The profile title is “Active Business User”, and specifies that the user makes video calls, has an average data rate of 1 Mbps and a mobility of 1 m/s. For such a profile, the orchestration component 106 applies rules to give the end user device 12a sufficient bandwidth and a sufficiently low latency data connection to allow video calling to be performed by the end user device 12a. Additionally, for such a profile, in which the end user device 12a has a high mobility, the network 100 proactively hands over the end user device 12a to another wireless access point, with a hand over taking place when signal strength falls to a high threshold value (i.e. fast handover).

In alternative examples, where an end user device has a better subscription class, the end user device is given preferential service (e.g. increased bandwidth).

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of managing resources of a network, the method comprising:
a profile mapping step comprising assigning a profile to an end user device; and
an orchestration step comprising using the profile to apply rules to network elements to manage resources of the network available to the end user device.

2. A method according to claim 1 comprising a profile editing step, the profile editing step comprising performing an initial selection of the profile before the profile mapping step.

3. A method according to claim 2, wherein the initial selection of the profile depends on at least one of a class of the end user device and an end user subscription class.

4. A method according to claim 1, wherein the profile mapping step comprises a profile building step, the profile building step comprising learning from patterns of behaviour of the end user device to build the profile before assigning the profile to the end user device.

5. A method according to claim 4, wherein the patterns of behaviour comprise a mobility speed of the end user device.

6. A method according to claim 4, wherein the patterns of behaviour comprise a traffic type of the end user device.

7. A method according to claim 4, wherein the patterns of behaviour comprise a mobility frequency of the end user device.

8. A method according to claim 4, wherein the patterns of behaviour comprise an average data rate usage of the end user device.

9. A method according to claim 4, wherein the patterns of behaviour are collected from at least one of a firewall, a wireless LAN controller and a switch.

10. A method according to claim 4, comprising a further profile building step, a further profile mapping step, and a further orchestration step.

11. A method according to claim 1, wherein the rules determine bandwidth available to the end user device.

12. A resource management system for a network, the resource management system comprising:
a profile mapper adapted to assign a profile to an end user device; and
an orchestration component adapted to use the profile to apply rules to network elements to manage resources of the network available to the end use device.
